(19) United States
(12) Patent Application Publication
(10) Pub. No.: US 2025/0173648 A1
(43) Pub. Date: May 29, 2025

(54) AUTOMATICALLY GENERATING A WORKFLOW USING RESPONSES TO AI-GENERATED INQUIRIES AS INPUTS TO A GENERATIVE AI MODEL

(71) Applicant: Microsoft Technology Licensing, LLC, Redmond, WA (US)

(72) Inventors: Lan LI, Issaquah, WA (US); Ankit MALHAN, Vancouver, British Columbia (CA); Ashvini SHARMA, Redmond, WA (US); Chhaya METHANI, Bothell, WA (US); David Robert REABURN, Redmond, WA (US); Sarosh Cyrus HAVEWALA, Redmond, WA (US); Keith Robert KINNAN, Sammamish, WA (US); Nina Rhodes WILLIAMS, Snohomish, WA (US); Juhi Pradeep PARALKAR, Wilmington, MA (US)

(21) Appl. No.: 18/421,951

(22) Filed: Jan. 24, 2024

Related U.S. Application Data
(60) Provisional application No. 63/603,058, filed on Nov. 27, 2023.

(51) Int. Cl. G06Q 10/0631; G06V 40/20

(52) U.S. Cl. CPC G06Q 10/06312; G06V 40/20

(57) ABSTRACT

Techniques are described herein that are capable of automatically generating a workflow using responses to AI-generated inquiries as inputs to a generative AI model. An initial prompt from a user is provided as an input to a generative AI model. The initial prompt indicates that a task is to be completed. Inquiries are provided in a first successive order to the user. The inquiries are generated by the generative AI model based at least on the initial prompt. The inquiries solicit information regarding the task. Response prompts are received in a second successive order that corresponds to the first successive order. The response prompts are responses to the respective inquiries. The generative AI model is caused to automatically generate a workflow, which is configured to achieve the task, based at least on the response prompts.

### CROSS-REFERENCE TO RELATED APPLICATION(S)

This application claims the benefit of U.S. Provisional Application No. 63/603,058, filed Nov. 27, 2023 and entitled “Automatically Generating a Workflow Using Responses to AI-Generated Inquiries as Inputs to a Generative AI Model,” the entirety of which is incorporated herein by reference.

### BACKGROUND

A workflow defines operations (e.g., processing steps) that are to be performed to achieve a task. For instance, the workflow may be implemented in executable code that, when executed, performs the operations that achieve the task. Workflows historically have been generated manually. However, manual generation of workflows often consumes a substantial amount of time and resources and sometimes requires specialized knowledge of the operations that are to be included in the workflows.

Workflow automation software has therefore been developed to automate the generation of workflows. However, conventional workflow automation software has its limitations. For instance, workflow automation software traditionally uses a single, detailed description of operations that are to be included in a workflow in an effort to automate the generation of the workflow to achieve a desired task. If the description is not sufficiently descriptive, the workflow automation software may not be able to generate the workflow or may generate a workflow that is incapable of achieving the task. Accordingly, even when using workflow automation software to generate a workflow, a user ultimately may generate a portion or all of the workflow manually.

### SUMMARY

It may be desirable for a generative artificial intelligence (AI) model to have a dialog (e.g., a conversation) with a user to refine an understanding of a task that is to be achieved by a workflow and to use that understanding to automatically generate the workflow. In an aspect, when the user generates an initial prompt, indicating that a task is to be completed, the initial prompt is provided to the generative AI model for processing. Providing the initial prompt to the generative AI model triggers the generative AI model to initiate the dialog regarding the task with the user. In accordance with this aspect, the dialog includes the generative AI model asking a series of questions about the task and receiving a series of answers to the respective questions from the user. For example, the generative AI model uses the initial prompt to determine a first question in the series of questions. The generative AI model uses the user's answer to the first question and any other suitable information (e.g., the initial prompt and/or other statements of the user) to determine a second question in the series of questions, and so on. Based at least on the user's answers that are received during the dialog, the generative AI model generates the workflow to achieve the task. Having the dialog with the user may enable the generative AI model to identify the operations that are to be included in the workflow more accurately, precisely, and/or reliably and may increase a likelihood that the workflow will be capable of achieving the task.

A generative artificial intelligence model is an artificial intelligence model that is capable of generating text, images, and/or other media using artificial intelligence. An artificial intelligence model is a model that utilizes artificial intelligence to achieve a task that is indicated by an artificial intelligence prompt (a.k.a. prompt) that is received by the artificial intelligence model. The artificial intelligence model may be an artificial general intelligence model. An artificial general intelligence model is an artificial intelligence model (e.g., an autonomous artificial intelligence model) that is configured to be capable of performing any task that an animal (e.g., a human) is capable of performing. In an example implementation, the artificial general intelligence model is capable of performing a task that surpasses the capabilities of an animal. Artificial intelligence is intelligence of a machine (e.g., a computing system) and/or code (e.g., software and/or firmware), as opposed to intelligence of an animal (e.g., a human).

An artificial intelligence prompt indicates (e.g., specifies) a task that is to be achieved (e.g., performed) by an artificial intelligence model. In an aspect, the artificial intelligence prompt is written in natural language. Examples of an artificial intelligence prompt include but are not limited to a zero-shot prompt, a one-shot prompt, and a few-shot prompt. A zero-shot prompt is a prompt for which the prompt and/or its corresponding contextual information, which are to be processed by the artificial intelligence model, is not included in pre-trained knowledge of the artificial intelligence model. A one-shot prompt is a prompt that includes a target prompt along with a single example prompt and a single example result (e.g., workflow) that results from (e.g., is responsive to) the single example prompt. The example prompt and the example result provide guidance as to how the artificial intelligence model is expected to respond to the target prompt. A few-shot prompt is a prompt that includes a target prompt along with multiple example prompts and multiple example results that result from the respective example prompts. The example prompts and the example results provide guidance as to how the artificial intelligence model is expected to respond to the target prompt.

Various approaches are described herein for, among other things, automatically generating a workflow using responses to AI-generated inquiries as inputs to a generative AI model. An AI-generated inquiry is an inquiry that is generated by an artificial intelligence model. A response to the AI-generated inquiry may be generated by a user to whom the AI-generated inquiry is provided. In an example approach, an initial prompt from a user is provided as an input to a generative AI model. The initial prompt indicates that a task is to be completed. Inquiries are provided in a first successive order to the user. The inquiries are generated by the generative AI model based at least on (e.g., as a result of or in response to) the initial prompt. The inquiries solicit information regarding the task. Response prompts are received in a second successive order that corresponds to the first successive order. The response prompts are responses to the respective inquiries. The generative AI model is caused to automatically generate a workflow, which is configured to achieve the task, based at least on inputs to the generative AI model by providing the response prompts as the inputs to the generative AI model.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Moreover, it is noted that the invention is not limited to the specific embodiments described in the Detailed Description and/or other sections of this document. Such embodiments are presented herein for illustrative purposes only. Additional embodiments will be apparent to persons skilled in the relevant art(s) based on the teachings contained herein.

### BRIEF DESCRIPTION OF THE DRAWINGS/FIGURES

The accompanying drawings, which are incorporated herein and form part of the specification, illustrate embodiments of the present invention and, together with the description, further serve to explain the principles involved and to enable a person skilled in the relevant art(s) to make and use the disclosed technologies.

FIG. 1 is a block diagram of an example inquiry-based workflow generation system in accordance with an embodiment.

FIG. 2 is an example activity diagram for automatically generating a workflow using responses to AI-generated inquiries as inputs to a generative AI model in accordance with an embodiment.

FIGS. 3-6 depict flowcharts of example methods for automatically generating a workflow using responses to AI-generated inquiries as inputs to a generative AI model in accordance with embodiments.

FIG. 7 is a block diagram of an example computing system in accordance with an embodiment.

FIG. 8 depicts an example computer in which embodiments may be implemented.

The features and advantages of the disclosed technologies will become more apparent from the detailed description set forth below when taken in conjunction with the drawings, in which like reference characters identify corresponding elements throughout. In the drawings, like reference numbers generally indicate identical, functionally similar, and/or structurally similar elements. The drawing in which an element first appears is indicated by the leftmost digit(s) in the corresponding reference number.

### DETAILED DESCRIPTION

### I. Example Embodiments

It may be desirable for a generative artificial intelligence (AI) model to have a dialog (e.g., a conversation) with a user to refine an understanding of a task that is to be achieved by a workflow and to use that understanding to automatically generate the workflow. In an aspect, when the user generates an initial prompt, indicating that a task is to be completed, the initial prompt is provided to the generative AI model for processing. Providing the initial prompt to the generative AI model triggers the generative AI model to initiate the dialog regarding the task with the user. In accordance with this aspect, the dialog includes the generative AI model asking a series of questions about the task and receiving a series of answers to the respective questions from the user. For example, the generative AI model uses the initial prompt to determine a first question in the series of questions. The generative AI model uses the user's answer to the first question and any other suitable information (e.g., the initial prompt and/or other statements of the user) to determine a second question in the series of questions, and so on. Based at least on the user's answers that are received during the dialog, the generative AI model generates the workflow to achieve the task. Having the dialog with the user may enable the generative AI model to identify the operations that are to be included in the workflow more accurately, precisely, and/or reliably and may increase a likelihood that the workflow will be capable of achieving the task.

A generative artificial intelligence model is an artificial intelligence model that is capable of generating text, images, and/or other media using artificial intelligence. An artificial intelligence model is a model that utilizes artificial intelligence to achieve a task that is indicated by an artificial intelligence prompt (a.k.a. prompt) that is received by the artificial intelligence model. The artificial intelligence model may be an artificial general intelligence model. An artificial general intelligence model is an artificial intelligence model (e.g., an autonomous artificial intelligence model) that is configured to be capable of performing any task that an animal (e.g., a human) is capable of performing. In an example implementation, the artificial general intelligence model is capable of performing a task that surpasses the capabilities of an animal. Artificial intelligence is intelligence of a machine (e.g., a computing system) and/or code (e.g., software and/or firmware), as opposed to intelligence of an animal (e.g., a human).

An artificial intelligence prompt indicates (e.g., specifies) a task that is to be achieved (e.g., performed) by an artificial intelligence model. In an aspect, the artificial intelligence prompt is written in natural language. Examples of an artificial intelligence prompt include but are not limited to a zero-shot prompt, a one-shot prompt, and a few-shot prompt. A zero-shot prompt is a prompt for which the prompt and/or its corresponding contextual information, which are to be processed by the artificial intelligence model, is not included in pre-trained knowledge of the artificial intelligence model. A one-shot prompt is a prompt that includes a target prompt along with a single example prompt and a single example result (e.g., workflow) that results from (e.g., is responsive to) the single example prompt. The example prompt and the example result provide guidance as to how the artificial intelligence model is expected to respond to the target prompt. A few-shot prompt is a prompt that includes a target prompt along with multiple example prompts and multiple example results that result from the respective example prompts. The example prompts and the example results provide guidance as to how the artificial intelligence model is expected to respond to the target prompt.

Example embodiments described herein are capable of automatically generating a workflow using responses to AI-generated inquiries as inputs to a generative AI model. An AI-generated inquiry is an inquiry that is generated by an artificial intelligence model. A response to the AI-generated inquiry may be generated by a user to whom the AI-generated inquiry is provided. In an example approach, an initial prompt from a user is provided as an input to a generative AI model. The initial prompt indicates that a task is to be completed. Inquiries are provided in a first successive order to the user. The inquiries are generated by the generative AI model based at least on (e.g., as a result of or in response to) the initial prompt. The inquiries solicit information regarding the task. Response prompts are received in a second successive order that corresponds to the first successive order. The response prompts are responses to the respective inquiries. The generative AI model is caused to automatically generate a workflow, which is configured to achieve the task, based at least on inputs to the generative AI model by providing the response prompts as the inputs to the generative AI model.

Example techniques described herein have a variety of benefits as compared to conventional techniques for generating a workflow. For instance, the example techniques are capable of causing a generative AI model to engage in a dialog with a user to refine an understanding of a task that is to be achieved, as indicated by the user. By enabling the generative AI model to refine the understanding of the task in this manner, the example techniques are capable of causing the generative AI model to generate a workflow, which is capable of achieving the task, more accurately, precisely, and/or reliably than conventional techniques.

The example techniques may reduce an amount of time and/or resources (e.g., processor cycles, memory, network bandwidth) that is consumed to generate a workflow. In a first example, providing inquiries, which are generated by a generative AI model based at least on an initial prompt, to a user to solicit information regarding a task that is indicated by the initial prompt may reduce the amount of time and/or resources that is consumed by a computing system to generate the workflow. In a second example, causing the generative AI model to automatically generate the workflow based at least on inputs to the generative AI model by providing response prompts, which are responses to the respective inquiries, as the inputs to the generative AI model may reduce the amount of time and/or resources that is consumed by the computing system to generate the workflow. Providing the inquiries to the user as described in the first example and/or causing the generative AI model to automatically generate the workflow by providing the response prompts as the inputs to the generative AI model as described in the second example may reduce an amount of time and/or resources that would have otherwise been consumed by the computing system as a result of the user using the computing system to generate at least a portion of the workflow manually. By reducing the amount of time and/or resources that is consumed, the efficiency of the computing system may be increased.

The example techniques may increase a user experience of a user who indicates that a task is to be achieved, for example, by automating generation of a workflow that is configured to achieve the task. For instance, by providing the inquiries to the user as described in the first example above and/or causing the generative AI model to automatically generate the workflow by providing the response prompts as the inputs to the generative AI model as described in the second example above, the example techniques may automate operations that otherwise would be performed by the user, which may reduce an amount of time consumed and/or effort expended by the user to generate the workflow. The example techniques may increase an efficiency of the user by reducing the amount of time that the user otherwise would have consumed to generate the workflow.

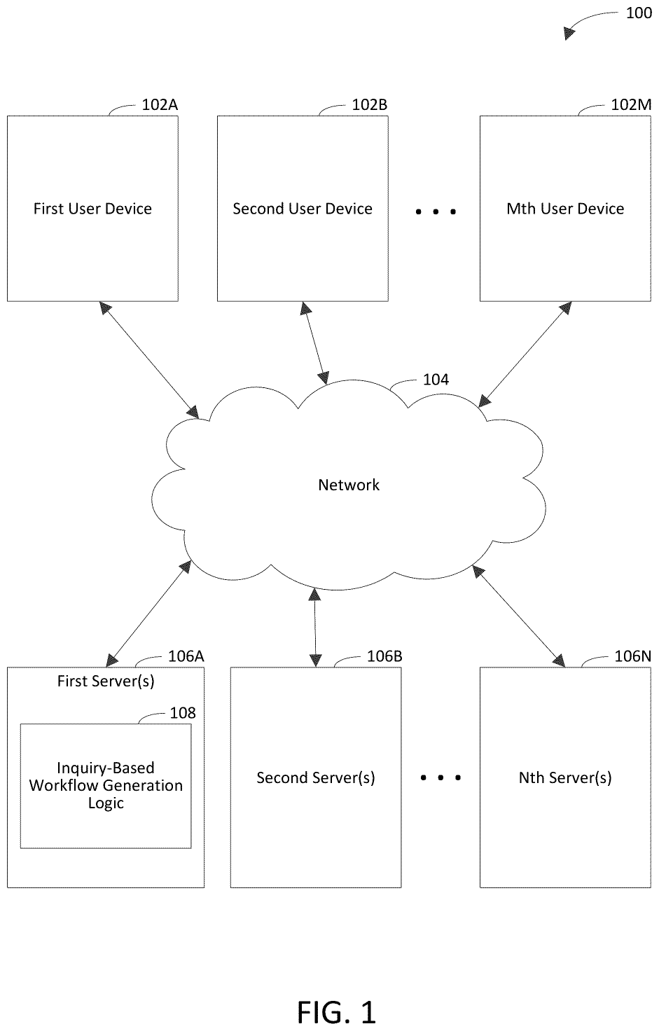

FIG. 1 is a block diagram of an example inquiry-based workflow generation system 100 in accordance with an embodiment. Generally speaking, the inquiry-based workflow generation system 100 operates to provide information to users in response to requests (e.g., hypertext transfer protocol (HTTP) requests) that are received from the users. The information may include documents (Web pages, images, audio files, video files, etc.), output of executables, and/or any other suitable type of information. In accordance with example embodiments described herein, the inquiry-based workflow generation system 100 automatically generates a workflow using responses to AI-generated inquiries as inputs to a generative AI model. Detail regarding techniques for automatically generating a workflow using responses to AI-generated inquiries as inputs to a generative AI model is provided in the following discussion.

As shown in FIG. 1, the inquiry-based workflow generation system 100 includes a plurality of user devices 102A-102M, a network 104, and a plurality of servers 106A-106N. Communication among the user devices 102A-102M and the servers 106A-106N is carried out over the network 104 using well-known network communication protocols. The network 104 may be a wide-area network (e.g., the Internet), a local area network (LAN), another type of network, or a combination thereof.

The user devices 102A-102M are computing systems that are capable of communicating with servers 106A-106N. A computing system is a system that includes at least a portion of a processor system such that the portion of the processor system includes at least one processor that is capable of manipulating data in accordance with a set of instructions. A processor system includes one or more processors, which may be on a same (e.g., single) device or distributed among multiple (e.g., separate) devices. For instance, a computing system may be a computer, a personal digital assistant, etc. The user devices 102A-102M are configured to provide requests to the servers 106A-106N for requesting information stored on (or otherwise accessible via) the servers 106A-106N. For instance, a user may initiate a request for executing a computer program (e.g., an application) using a client (e.g., a Web browser, Web crawler, or other type of client) deployed on a user device 102 that is owned by or otherwise accessible to the user. In accordance with some example embodiments, the user devices 102A-102M are capable of accessing domains (e.g., Web sites) hosted by the servers 104A-104N, so that the user devices 102A-102M may access information that is available via the domains. Such domain may include Web pages, which may be provided as hypertext markup language (HTML) documents and objects (e.g., files) that are linked therein, for example.

Each of the user devices 102A-102M may include any client-enabled system or device, including but not limited to a desktop computer, a laptop computer, a tablet computer, a wearable computer such as a smart watch or a head-mounted computer, a personal digital assistant, a cellular telephone, an Internet of things (IoT) device, or the like. It will be recognized that any one or more of the user devices 102A-102M may communicate with any one or more of the servers 106A-106N.

The servers 106A-106N are computing systems that are capable of communicating with the user devices 102A-102M. The servers 106A-106N are configured to execute computer programs that provide information to users in response to receiving requests from the users. For example, the information may include documents (Web pages, images, audio files, video files, etc.), output of executables, or any other suitable type of information. In accordance with some example embodiments, the servers 106A-106N are configured to host respective Web sites, so that the Web sites are accessible to users of the complex expression-based metadata generation system 100.

One example type of computer program that may be executed by one or more of the servers 106A-106N is a cloud computing program (a.k.a. cloud service). A cloud computing program is a computer program that provides hosted service(s) via a network (e.g., network 104). For instance, the hosted service(s) may be hosted by any one or more of the servers 106A-106N. The cloud computing program may enable users (e.g., at any of the user systems 102A-102M) to access shared resources that are stored on or are otherwise accessible to the server(s) via the network.

The cloud computing program may provide hosted service(s) according to any of a variety of service models, including but not limited to Backend as a Service (BaaS), Software as a Service (SaaS), Platform as a Service (PaaS), and Infrastructure as a Service (IaaS). BaaS enables applications (e.g., software programs) to use a BaaS provider's backend services (e.g., push notifications, integration with social networks, and cloud storage) running on a cloud infrastructure. SaaS enables a user to use a SaaS provider's applications running on a cloud infrastructure. PaaS enables a user to develop and run applications using a PaaS provider's application development environment (e.g., operating system, programming-language execution environment, database) on a cloud infrastructure. IaaS enables a user to use an IaaS provider's computer infrastructure (e.g., to support an enterprise). For example, IaaS may provide to the user virtualized computing resources that utilize the IaaS provider's physical computer resources.

Examples of a cloud computing program include but are not limited to Google Cloud® developed and distributed by Google Inc., Oracle Cloud® developed and distributed by Oracle Corporation, Amazon Web Services® developed and distributed by Amazon.com, Inc., Salesforce® developed and distributed by Salesforce.com, Inc., AppSource® developed and distributed by Microsoft Corporation, Azure® developed and distributed by Microsoft Corporation, GoDaddy® developed and distributed by GoDaddy.com LLC, and Rackspace® developed and distributed by Rackspace US, Inc. It will be recognized that the example techniques described herein may be implemented using a cloud computing program. For instance, a software product (e.g., a subscription service, a non-subscription service, or a combination thereof) may include the cloud computing program, and the software product may be configured to perform the example techniques, though the scope of the example embodiments is not limited in this respect.

The first server(s) 106A are shown to include inquiry-based workflow generation logic 108 for illustrative purposes. The inquiry-based workflow generation logic 108 is configured to automatically generate a workflow using responses to AI-generated inquiries as inputs to a generative AI model. The inquiry-based workflow generation logic 108 provides an initial prompt from a user as an input to a generative AI model. The initial prompt indicates that a task is to be completed. The inquiry-based workflow generation logic 108 provides inquiries in a first successive order to the user. The inquiries are generated by the generative AI model based at least on the initial prompt. The inquiries solicit information regarding the task. The inquiry-based workflow generation logic 108 receives response prompts in a second successive order that corresponds to the first successive order. The response prompts are responses to the respective inquiries. The inquiry-based workflow generation logic 108 causes the generative AI model to automatically generate a workflow, which is configured to achieve the task, based at least on inputs to the generative AI model by providing the response prompts as the inputs to the generative AI model.

The inquiry-based workflow generation logic 108 may be implemented in various ways to automatically generate a workflow using responses to AI-generated inquiries as inputs to a generative AI model, including being implemented in hardware, software, firmware, or any combination thereof. For example, the inquiry-based workflow generation logic 108 may be implemented as computer program code configured to be executed in one or more processors. In another example, at least a portion of the inquiry-based workflow generation logic 108 may be implemented as hardware logic/electrical circuitry. For instance, at least a portion of the inquiry-based workflow generation logic 108 may be implemented in a field-programmable gate array (FPGA), an application-specific integrated circuit (ASIC), an application-specific standard product (ASSP), a system-on-a-chip system (SoC), a complex programmable logic device (CPLD), etc. Each SoC may include an integrated circuit chip that includes one or more of a processor (a microcontroller, microprocessor, digital signal processor (DSP), etc.), memory, one or more communication interfaces, and/or further circuits and/or embedded firmware to perform its functions.

It will be recognized that the inquiry-based workflow generation logic 108 may be (or may be included in) a cloud computing program, though the scope of the example embodiments is not limited in this respect.

The inquiry-based workflow generation logic 108 is shown to be incorporated in the first server(s) 106A for illustrative purposes and is not intended to be limiting. It will be recognized that the inquiry-based workflow generation logic 108 (or any portion(s) thereof) may be incorporated in any one or more of the servers 106A-106N, any one or more of the user devices 102A-102M, or any combination thereof. For example, client-side aspects of the inquiry-based workflow generation logic 108 may be incorporated in one or more of the user devices 102A-102M, and server-side aspects of inquiry-based workflow generation logic 108 may be incorporated in one or more of the servers 106A-106N.

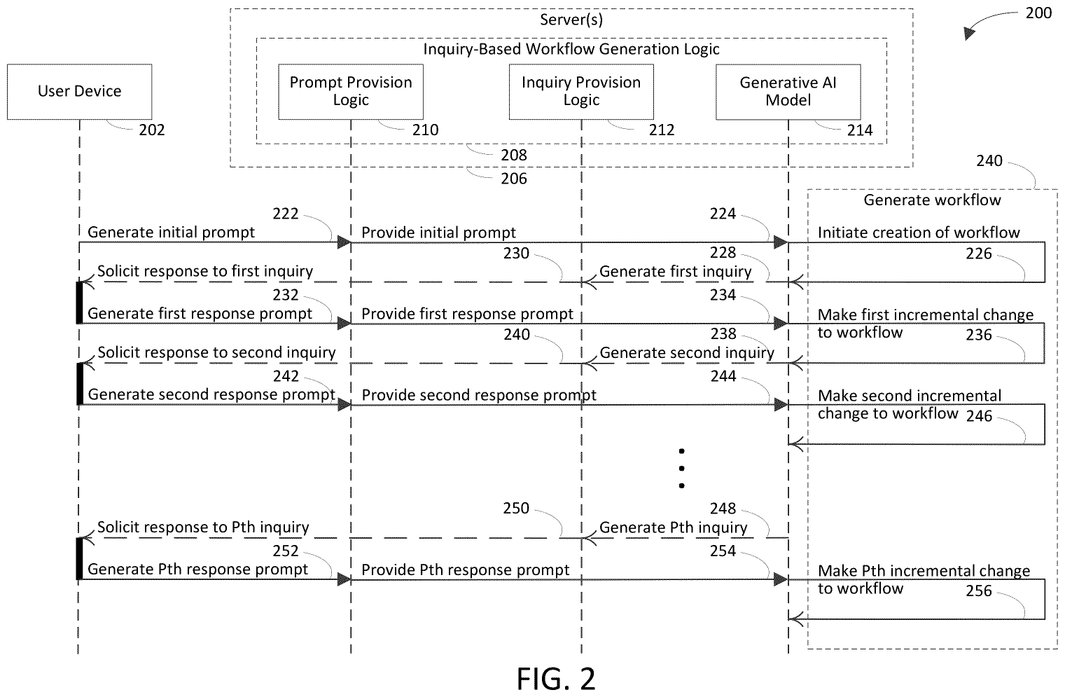

FIG. 2 is an example activity diagram 200 for automatically generating a workflow using responses to AI-generated inquiries as inputs to a generative AI model in accordance with an embodiment. FIG. 2 depicts a user device 202 and server(s) 206. The server(s) 206 include inquiry-based workflow generation logic 208. The inquiry-based workflow generation logic 208 includes prompt provision logic 210, inquiry provision logic 212, and a generative AI model 214. Activities 222, 224, 226, 228, 230, 232, 234, 236, 238, 240, 242, 244, 246, 248, 250, 252, 254, and 256 will now be described with reference to the prompt provision logic 210, the inquiry provision logic 212, and the generative AI model 214.

In activity 222, the user device 202 generates an initial prompt, which indicates a task that is to be achieved. For example, the initial prompt may be relatively vague and provide few or no details regarding the task that is to be achieved. In another example, the task to be achieved may be resolution of a business problem.

In an example hiring implementation, the initial prompt reads, “My hiring process is full of manual steps. Can you help me streamline?” In accordance with this example, the task indicated by the initial prompt is “streamlining the hiring process.” Streamlining the hiring process includes automating any one or more (e.g., all) steps of the hiring process. Streamlining the hiring process may further include reducing a number of steps in the hiring process.

In activity 224, the prompt provision logic 210 provides (e.g., forwards) the initial prompt that is received from the user device 202 to the generative AI model 214 for processing.

In activity 226, the generative AI model 214 initiates creation of a workflow based on (e.g., based at least on) receipt of the initial prompt from the prompt provision logic 210. For example, the generative AI model 214 may derive (e.g., infer) an intent to achieve the task by analyzing content (e.g., natural language content) of the initial prompt. In accordance with this example, the generative AI model 214 may determine an extent of automation that the workflow is capable of providing to perform the task. In further accordance with this example, the generative AI model 214 may initiate the creation of the workflow based at least on the extent of the automation being greater than or equal to an extent threshold.

In activity 228, the generative AI model 214 generates a first inquiry, which requests information regarding the task that is indicated by the initial prompt.

In the example hiring implementation mentioned above with reference to activity 222, the generative AI model 214 analyzes historical information about steps that the user and/or other users have previously performed in order to make a hiring decision. In accordance with this example, the generative AI model 214 identifies a first category of steps that are frequently performed during a hiring process and a second category of steps that are occasionally (but not frequently) performed during a hiring process. In further accordance with this example, the first inquiry reads, “Here are some actions that are frequently performed during the hiring process: <list of steps in first category>. Would you like for me to automate these actions?”

In activity 230, the inquiry provision logic 212 solicits a response to the first inquiry by providing the first inquiry to the user device 202.

In activity 232, the user device 202 generates a first response prompt, which is a response to the first inquiry. The first response prompt includes first information regarding the task.

In the example hiring implementation, the first response prompt reads, “Yes, please automate those steps, except I don't need to perform step X.”

In activity 234, the prompt provision logic 210 provides the first response prompt that is received from the user device 202 to the generative AI model 214 for processing.

In activity 236, the generative AI model 214 makes a first incremental change to the workflow based on receipt of the first response prompt from the prompt provision logic 210. For example, the generative AI model 214 may determine that the first incremental change is to be made to the workflow based on content of the first response prompt.

In the example hiring implementation, the generative AI model 214 modifies the workflow to include all the steps in the first category, except for step X.

In activity 238, the generative AI model 214 generates a second inquiry, which requests additional information regarding the task that is indicated by the initial prompt.

In the example hiring implementation, the generative AI model 214 determines that multiple email tools are capable of performing step Y, which was added to the workflow in activity 236. In accordance with this example, the second inquiry reads, “Here are the email tools that you can use to perform step Y. Which one would you like to use?”

In activity 240, the inquiry provision logic 212 solicits a response to the second inquiry by providing the second inquiry to the user device 202.

In activity 242, the user device 202 generates a second response prompt, which is a response to the second inquiry. The second response prompt includes second information regarding the task.

In the example hiring implementation, the second response prompt reads, “Let's use Outlook.”

In activity 244, the prompt provision logic 210 provides the second response prompt that is received from the user device 202 to the generative AI model 214 for processing.

In activity 246, the generative AI model 214 makes a second incremental change to the workflow based on receipt of the second response prompt from the prompt provision logic 210. For example, the generative AI model 214 may determine that the second incremental change is to be made to the workflow based on content of the second response prompt.

In the example hiring implementation, the generative AI model 214 modifies the workflow to use the Outlook® email program, which is developed and distributed by Microsoft Corporation, to perform step Y.

In activity 248, the generative AI model 214 generates a Pth inquiry, which requests additional information regarding the task that is indicated by the initial prompt.

In the example hiring implementation, the generative AI model 214 determines that step Z, which is included in the second category of steps identified in activity 228, is included in a proportion of hiring processes that is greater than or equal to a threshold proportion. For instance, step Z may be included in 28% of the hiring processes identified by the generative AI model 214, and the threshold proportion may be 25%. In accordance with this implementation, the Pth inquiry reads, “Would you like to perform step Z, as well?”

In activity 250, the inquiry provision logic 212 solicits a response to the Pth inquiry by providing the Pth inquiry to the user device 202.

In activity 252, the user device 202 generates a Pth response prompt, which is a response to the Pth inquiry. The Pth response prompt includes Pth information regarding the task.

In the example hiring implementation, the Pth response reads, “Sure, let's do that for all management positions.”

In activity 254, the prompt provision logic 210 provides the Pth response prompt that is received from the user device 202 to the generative AI model 214 for processing.

In activity 256, the generative AI model 214 makes a Pth incremental change to the workflow based on receipt of the Pth response prompt from the prompt provision logic 210. For example, the generative AI model 214 may determine that the Pth incremental change is to be made to the workflow based on content of the Pth response prompt.

In the example hiring implementation, the generative AI model 214 modifies the workflow to include a conditional step, which is to be conditionally performed depending on whether a job candidate is applying for a management position or a non-management position. In accordance with this implementation, the generative AI Model 214 configures the workflow to trigger performance of step Z for all management positions and not to trigger performance of step Z for non-management positions.

Dashed box 240 represents generation of the workflow by the generative AI model 214. Accordingly, the dashed box 240 includes activities 226, 236, 246, and 256, indicating that the generative AI model 214 performs activities 226, 236, 246, and 256 to generate the workflow. It will be recognized that the generative AI model 214 may generate any suitable number of inquiries and make any suitable number of incremental changes to the workflow based on any suitable number of response prompts, which are responsive to the inquiries.

In an example embodiment, the generative AI model 214 is a large language model (LLM). A large language model is an artificial neural network that is capable of performing natural language processing (NLP) tasks. For instance, the large language model may use a transformer model to perform the NLP tasks. In an aspect, the large language model is trained (e.g., pre-trained) using self-supervised learning and semi-supervised learning. Examples of a large language model include but are not limited to the GPT-3 and GPT-4 models, developed and distributed by OpenAI, Inc.; the LLaMA model, developed and distributed by Meta Platforms Inc.; and the PaLM model, developed and distributed by Google LLC.

In some example embodiments, one or more of the activities 222, 224, 226, 228, 230, 232, 234, 236, 238, 240, 242, 244, 246, 248, 250, 252, 254, and/or 256 of the activity diagram 200 may not be performed. Moreover, activities in addition to or in lieu of the activities 222, 224, 226, 228, 230, 232, 234, 236, 238, 240, 242, 244, 246, 248, 250, 252, 254, and/or 256 may be performed.

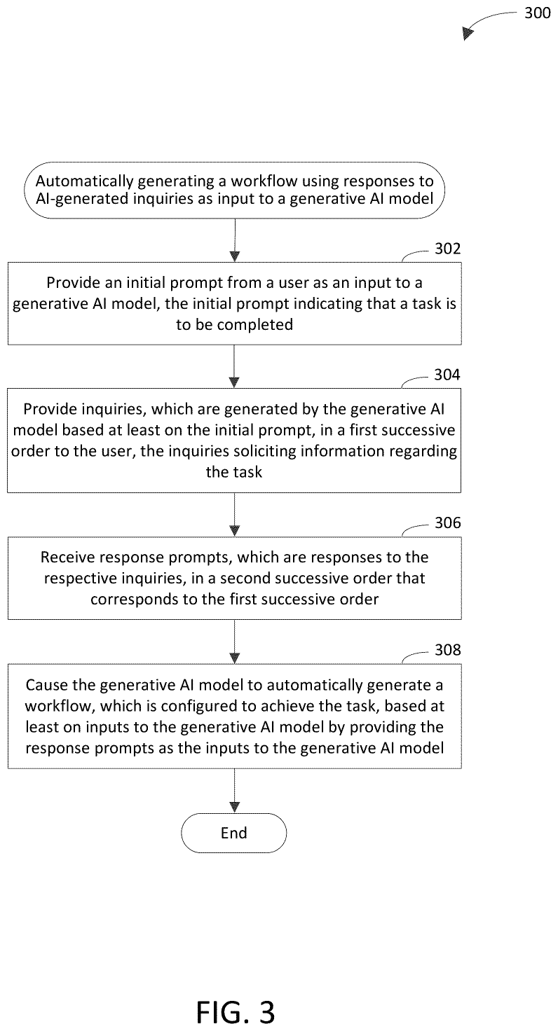

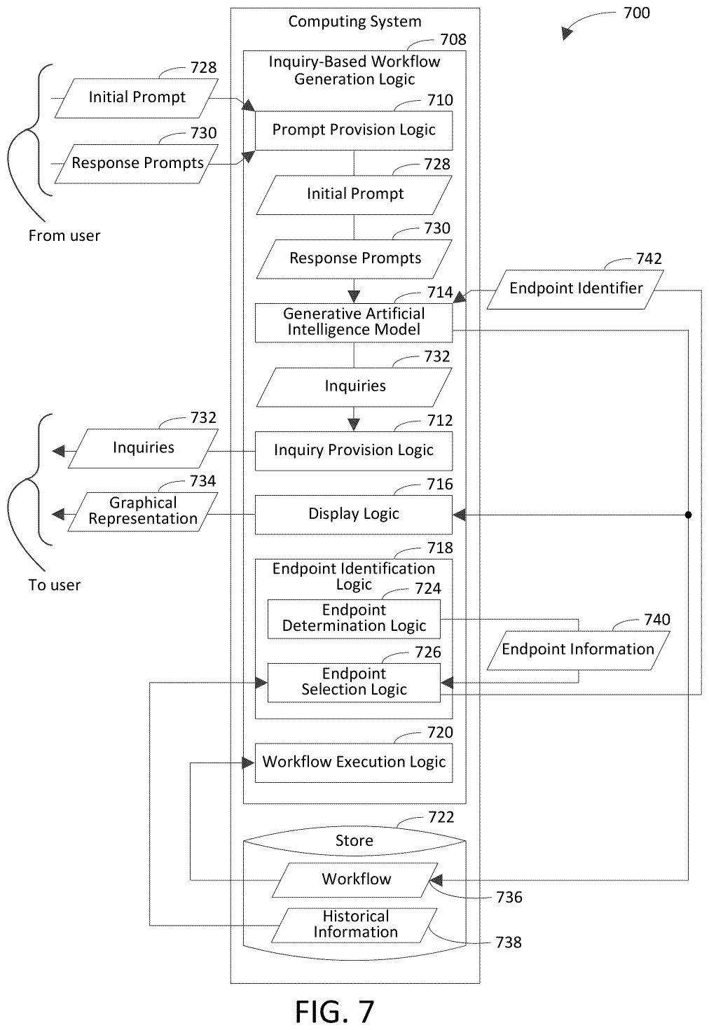

FIGS. 3-6 depict flowcharts 300, 400, 500, and 600 of example methods for automatically generating a workflow using responses to AI-generated inquiries as inputs to a generative AI model in accordance with embodiments. Flowcharts 300, 400, 500, and 600 may be performed by the first server(s) 106A shown in FIG. 1, for example. For illustrative purposes, flowcharts 300, 400, 500, and 600 are described with respect to a computing system 700 shown in FIG. 7, which is an example implementation of the first server(s) 106A. As shown in FIG. 7, the computing system 700 includes inquiry-based workflow generation logic 708 and a store 722. The inquiry-based workflow generation logic 708 includes prompt provision logic 710, inquiry provision logic 712, a generative artificial intelligence (AI) model 714, display logic 716, endpoint identification logic 718, and workflow execution logic 720. The endpoint identification logic 718 includes endpoint determination logic 724 and endpoint selection logic 726. The store 722 may be any suitable type of store. One type of store is a database. For instance, the store 722 may be a relational database, an entity-relationship database, an object database, an object relational database, an extensible markup language (XML) database, etc. The store 722 is shown to store a workflow 736 and historical information 738 for non-limiting, illustrative purposes. Further structural and operational embodiments will be apparent to persons skilled in the relevant art(s) based on the discussion regarding flowcharts 300, 400, 500, and 600.

As shown in FIG. 3, the method of flowchart 300 begins at step 302. In step 302, an initial prompt from a user is provided as an input to a generative AI model. The initial prompt indicates that a task is to be completed. For instance, the initial prompt may request completion of the task. In an example implementation, prompt provision logic 710 provides an initial prompt 728, which is received from a user, as an input to the generative AI model 714. The initial prompt 728 indicates that the task is to be completed.

At step 304, inquiries are provided in a first successive order to the user. The inquiries are generated by the generative AI model based at least on the initial prompt. The inquiries solicit information regarding the task. In an example implementation, the inquiry provision logic 712 provides inquiries 732 in the first successive order to the user. In accordance with this implementation, the generative AI model 714 generates the inquiries 732 based at least on the initial prompt 728. The inquiries 732 solicit information regarding the task.

At step 306, response prompts are received in a second successive order that corresponds to the first successive order. The response prompts are responses to the respective inquiries. For example, the response prompts may include the information that is solicited by the inquiries. In an example implementation, the prompt provision logic 710 receives response prompts 730 in a second successive order that corresponds to the first successive order. The response prompts 730 are responses to the respective inquiries 732.

At step 308, the generative AI model is caused to automatically generate a workflow, which is configured to achieve the task, based at least on inputs to the generative AI model by providing the response prompts as the inputs to the generative AI model. In an example implementation, the prompt provision logic 710 causes the generative AI model 714 to automatically generate a workflow 736, which is configured to achieve the task, based at least on inputs to the generative AI model 714 by providing the response prompts 730 as the inputs to the generative AI model 714. In an aspect, the generative AI model 714 refines an understanding of the task to produces a refined understanding based on the response prompts 730 that are received from the prompt provision logic 710. In accordance with this aspect, the generative AI model configures the workflow based on the refined understanding of the task.

In an example embodiment, causing the generative AI model to automatically generate the workflow at step 308 includes causing the AI model to incrementally modify the workflow to include multiple incremental changes in the second successive order. In accordance with this embodiment, the incremental changes are triggered by the respective response prompts. For example, a first response prompt may trigger a first incremental change to the workflow; a second response prompt may trigger a second incremental change to the workflow, and so on.

In another example embodiment, causing the generative AI model to automatically generate the workflow at step 308 includes causing the generative AI model to configure the workflow to require human approval as a prerequisite for performance of an operation in the workflow by providing information about the operation as an input to the generative AI model. In accordance with this embodiment, the information about the operation provides context regarding a response prompt that is included in the response prompts received at step 306.

In yet another example embodiment, the inquiries include an identified inquiry that requests which endpoint of multiple endpoints is to be used to achieve the task. Each of the endpoints is capable of being used to achieve the task. An endpoint is a desktop application, a web application, or a web service. In accordance with this embodiment, the response prompts include an identified response prompt that is a response to the identified inquiry. The identified response prompt indicates that a designated endpoint of the endpoints is to be used to achieve the task. In further accordance with this embodiment, based at least on the identified response prompt indicating that the designated endpoint is to be used to achieve the task, the generative AI model is caused to automatically generate the workflow such that the workflow is configured to achieve the task by using the designated endpoint.

In still another example embodiment, the inquiries include an identified inquiry that identifies multiple operations that are capable of being added to the workflow. The identified inquiry requests an indication of which of the operations is to be added to the workflow. For instance, the identified inquiry may request an indication of which one of the operations is to be added to the workflow. In accordance with this embodiment, the response prompts include an identified response prompt that is a response to the identified inquiry. The identified response prompt indicates selection of a designated operation from the operations. In further accordance with this embodiment, causing the generative AI model to automatically generate the workflow includes, based at least on the identified response prompt indicating the selection of the designated operation from the operations, causing the generative AI model to add the designated operation to the workflow. For instance, the generative AI model may be caused to add the designated operation, rather than (e.g., in lieu of) the other operations, to the workflow.

In an example triggering embodiment, the inquiries include an identified inquiry that requests identification of a trigger action that is to trigger execution of the workflow. Examples of a trigger action include selection of an icon (e.g., pressing of a virtual button) in a user interface, receipt of a message (e.g., a message of a particular type), identification of a person in a particular category (e.g., a potential new customer or a potential new hire), and a determination that a value of a monitored parameter reaches a threshold value. In accordance with the triggering embodiment, the response prompts include an identified response prompt that is a response to the identified inquiry. In further accordance with the triggering embodiment, the identified response prompt identifies the trigger action that is to trigger the execution of the workflow. In further accordance with the triggering embodiment, causing the generative AI model to automatically generate the workflow at step 308 includes, based at least on the identified response prompt identifying the trigger action, causing the generative AI model to configure the workflow such that performance of the trigger action triggers the execution of the workflow. In an example implementation, the prompt provision logic 710 causes the generative AI model 714 to configure the workflow 736 to be triggered by the trigger action, for example, by generating an if-then statement, which indicates that if the trigger action is performed, then the workflow 736 is to be executed.

In an aspect of the triggering embodiment, the identified response prompt indicates that the trigger action is to be performed on a periodic schedule. The periodic schedule is based on a period that is equal to a specified fixed amount of time. In accordance with this aspect, the inquiries may include a follow-up inquiry, which is generated by the generative AI model based at least on the period indicated by the identified response not satisfying a criterion. The follow-up inquiry proposes that the periodic schedule be based on an alternative period that satisfies the criterion.

In an example of this aspect, the criterion requires the period indicated by the identified response to be greater than or equal to a period threshold. In accordance with this example, the generative AI model determines that the period indicated by the identified response is less than the period threshold. In further accordance with this example, the follow-up query proposes that the periodic schedule be based on the alternative period as a result of the alternative period being greater than or equal to the period threshold.

In another example of this aspect, the criterion requires the period indicated by the identified response to be less than or equal to a period threshold. In accordance with this example, the generative AI model determines that the period indicated by the identified response is greater than the period threshold. In further accordance with this example, the follow-up query proposes that the periodic schedule be based on the alternative period as a result of the alternative period being less than or equal to the period threshold.

In yet another example of this aspect, the criterion requires a likelihood of the period indicated by the identified response being included in a period range, which is defined by historical periods of historical periodic schedules on which the trigger action historically is performed, to be greater than or equal to a likelihood threshold. In accordance with this example, the generative AI model determines that a likelihood of the period indicated by the identified response being included in the period range is less than the likelihood threshold. In further accordance with this example, the follow-up query proposes that the periodic schedule be based on the alternative period as a result of a likelihood of the alternative period being included in the period range being greater than or equal to the likelihood threshold. For instance, a likelihood of a particular period being included in the period range may be based at least on a proportion of the historical periodic schedules that are based on the particular period.

In still another example of this aspect, the criterion requires an estimated amount of resources that is to be consumed to execute the workflow in accordance with the period indicated by the identified response prompt to be less than or equal to a consumption threshold. In accordance with this example, the generative AI model estimates that execution of the workflow in accordance with the period indicated by the identified response will consume an amount of resources that is greater than the consumption threshold. In further accordance with this example, the follow-up query proposes that the periodic schedule be based on the alternative period as a result of the generative AI model estimating that the amount of resources that is to be consumed to execute the workflow in accordance with the alternative period is less than or equal to the consumption threshold.

In another aspect of the triggering embodiment, the trigger action is an asynchronous event of a designated (e.g., predefined) type. An asynchronous event is an event that does not occur on a schedule having a fixed period. Example types of an asynchronous event include selection of an interface element (e.g., icon or widget) on a user interface, receipt of a message (e.g., an email message or a short message service (SMS) message), and a value of a monitored parameter reaching a threshold value.

It will be recognized that the user may initiate (e.g., perform) an asynchronous event to manually trigger execution of the workflow. For instance, the user may perform an action with regard to a user interface (e.g., select an interface element on a user interface or perform a gesture) to trigger the execution of the workflow. A gesture may be a touch gesture (e.g., touchpad gesture or touchscreen gesture), a hover gesture, or a combination thereof. A touch gesture is a gesture in which a user touches a touchpad or a touchscreen of a computing system. Examples of a touch gesture include but are not limited to a tap, a double tap, a long press, a pan, a flick, a pinch, a zoom, a rotate, a scroll or swipe, a two-finger tap, and a two-finger scroll. A hover gesture is a gesture that does not require a user to touch a touchpad or a touchscreen of a computing system. For instance, the user may perform the hover gesture by placing a hand and/or finger(s) at a spaced distance above a touchscreen. It will be recognized that the touchscreen can detect that the user's hand and/or finger(s) are proximate to the touchscreen (e.g., through capacitive sensing). Additionally, hand rotation and finger movement can be detected while the hand and/or finger(s) are hovering. Examples of a hover gesture include but are not limited to finger hover pan (e.g., float a finger above a screen and pan the finger in any direction); a finger hover flick (e.g., float a finger above the screen and quickly flick the finger); a finger hover circle (e.g., float a finger above the screen and draw a circle or counter-circle in the air); a finger hover hold (e.g., float a finger above the screen and keep the finger stationary); a palm swipe (e.g., float the edge of the hand or the palm of the hand and swipe across the screen); an air pinch/lift/drop (e.g., use the thumb and pointing finger to perform a pinch gesture above the screen, a drag motion, then a release motion); and a hand wave gesture (e.g., float the hand above the screen and move the hand back and forth in a hand-waving motion). It will be recognized that gestures may be detected in other ways, such as using a camera. In such instances, the user need not necessarily perform a hover gesture in proximity to a touchscreen. Rather, the user may perform the gesture in a field of view of a camera to enable the camera to detect the gesture.

In some example embodiments, one or more steps 302, 304, 306, and/or 308 of flowchart 300 may not be performed. Moreover, steps in addition to or in lieu of steps 302, 304, 306, and/or 308 may be performed. For instance, in an example embodiment, the method of flowchart 300 further includes providing a graphical representation of the workflow to the user. In an example implementation, the display logic 716 provides a graphical representation 734 of the workflow 736 to the user.

In another example embodiment, the method of flowchart 300 further includes, for each of the response prompts, causing a next successive inquiry of the inquiries to be generated by the generative AI model by providing the respective response prompt together with contextual information, which includes context regarding the respective response prompt, as inputs to the generative AI model. The contextual information includes at least a preceding prompt that precedes (e.g., immediately precedes) the respective response prompt. The preceding prompt includes (e.g., is) the initial prompt or another response prompt of the response prompts. In an example implementation, for each of the response prompts 730, the prompt provision logic 710 causes a next successive inquiry in the inquiries 732 to be generated by the generative AI model 714 by providing the respective response prompt together with the contextual information as inputs to the generative AI model 714. In accordance with this implementation, the contextual information includes at least the preceding prompt, which includes the initial prompt 728 or another response prompt in the response prompts 730.

In an aspect of this embodiment, for each of the response prompts, the contextual information regarding the respective response prompt includes the initial prompt and each of the response prompts that precedes the respective response prompt. For example, the contextual information regarding a temporally first response prompt includes the initial prompt and none of the other response prompts. In another example, the contextual information regarding a temporally second response prompt includes the initial prompt and the temporally first response prompt, but none of the other response prompts. In yet another example, the contextual information regarding a temporally third response prompt includes the initial prompt, the temporally first response prompt, and the temporally second response prompt, but none of the other response prompts.

In another aspect of this embodiment, for each of the response prompts, the contextual information regarding the respective response prompt includes the initial prompt and each of the response prompts that precedes the respective response prompt up to a maximum number of the response prompts. The maximum number may be any suitable number (e.g., 1, 2, 3, 5, 8, or 10). In an example implementation, the maximum number is set to equal one, meaning that the number of the response prompts that is included in the contextual information regarding each response prompt is limited to one. For instance, the prompt provision logic 710 may set the maximum number to be one. In accordance with this implementation, the contextual information regarding a temporally first response prompt includes the initial prompt and none of the other response prompts. In further accordance with this implementation, the contextual information regarding a temporally second response prompt includes the initial prompt and the temporally first response prompt, but none of the other response prompts. In further accordance with this implementation, the contextual information regarding a temporally third response prompt includes the initial prompt and either the temporally first response prompt or the temporally second response prompt, but none of the other response prompts. The contextual information regarding the temporally third response prompt does not include both the temporally first response prompt and the temporally second response prompt because the setting the maximum number to one limits the number of the response prompts in the contextual information to one.

In yet another aspect of this embodiment, for each of the response prompts, the contextual information regarding the respective response prompt includes a subset of the preceding prompts that immediately precedes the respective response prompt such that the subset is limited to a maximum number of the preceding prompts. Each preceding prompt includes (e.g., is) the initial prompt or another response prompt of the response prompts. The maximum number may be any suitable number (e.g., 1, 2, 3, 5, 8, or 10). In an example implementation, the maximum number is set to equal one, meaning that the contextual information regarding each response prompt includes a single most recent preceding prompt that precedes the respective response prompt. In accordance with this implementation, the contextual information regarding a temporally first response prompt includes the initial prompt and none of the other response prompts. In further accordance with this implementation, the contextual information regarding a temporally second response prompt includes the temporally first response prompt, does not include the initial prompt, and does not include any of the other response prompts. In further accordance with this implementation, the contextual information regarding a temporally third response prompt includes the temporally second response prompt, does not include the initial prompt, and does not include any of the other response prompts.

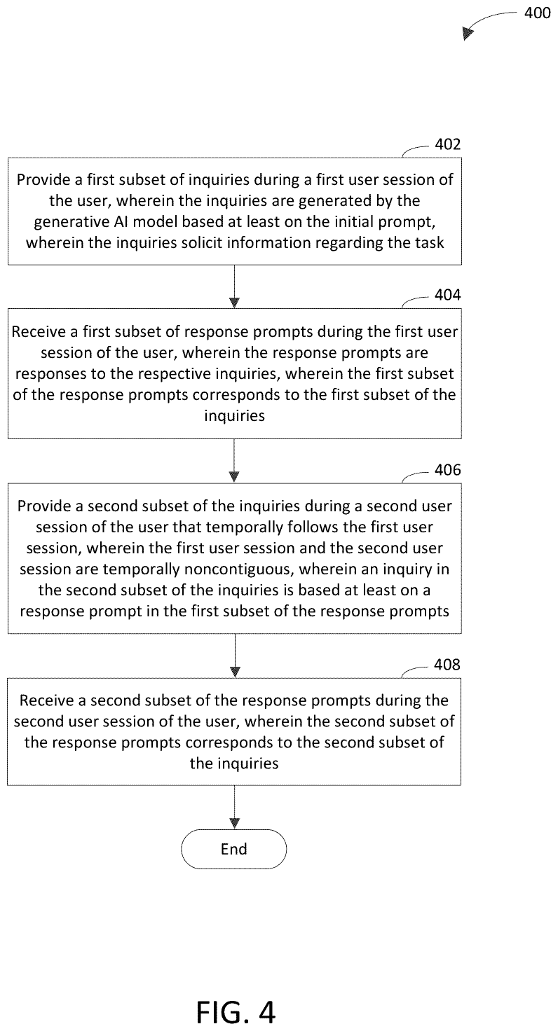

In still another example embodiment, steps 304 and 306 of flowchart 300 are replaced with one or more of the steps shown in flowchart 400 of FIG. 4. As shown in FIG. 4, the method of flowchart 400 begins at step 402. In step 402, a first subset of inquiries is provided during a first user session of the user. The inquiries are generated by the generative AI model based at least on the initial prompt. The inquiries solicit information regarding the task. A user session is a period of time during which a user remains in continuous dialog with an AI model. For instance, the user session may be defined to start at a time instance at which an initial prompt is received from the user. The user session may be defined to end based on a designated (e.g., predefined) amount of time passing since a most recent communication between the user and the AI model (e.g., a most recent prompt being received from the user or a most recent inquiry that is generated by the AI model being provided to the user) during the session without another prompt (e.g., another prompt that relates to the task) being received from the user. In an example implementation, the inquiry provision logic 712 provides a first subset of the inquiries 732 during the first user session of the user. The inquiries are generated by the generative AI model 714 based at least on the initial prompt 728. The inquiries 732 solicit information regarding the task.

At step 404, a first subset of response prompts is received during the first user session of the user. The response prompts are responses to the respective inquiries. The first subset of the response prompts corresponds to the first subset of the inquiries. In an example implementation, the prompt provision logic 710 receives a first subset of the response prompts 730 during the first user session of the user. The response prompts 730 are responses to the respective inquiries 732. The first subset of the response prompts 730 corresponds to the first subset of the inquiries 732.

At step 406, a second subset of the inquiries is provided during a second user session of the user that temporally follows the first user session. The first user session and the second user session are temporally noncontiguous. An inquiry in the second subset of the inquiries is based at least on a response prompt in the first subset of the response prompts. In an example implementation, the inquiry provision logic 712 provides a second subset of the inquiries 732 during the second user session of the user. An inquiry in the second subset of the inquiries 732 is based at least on a response prompt in the first subset of the response prompts 730.

At step 408, a second subset of the response prompts is received during the second user session of the user. The second subset of the response prompts corresponds to the second subset of the inquiries. In an example implementation, the prompt provision logic 710 receives a second subset of the response prompts 730 during the second user session of the user. The second subset of the response prompts 730 corresponds to the second subset of the inquiries 732.

In an aspect of this embodiment, steps 402 and 406 are included in step 304 of flowchart 300. In another aspect of this embodiment, steps 404 and 408 are included in step 306 of flowchart 300.

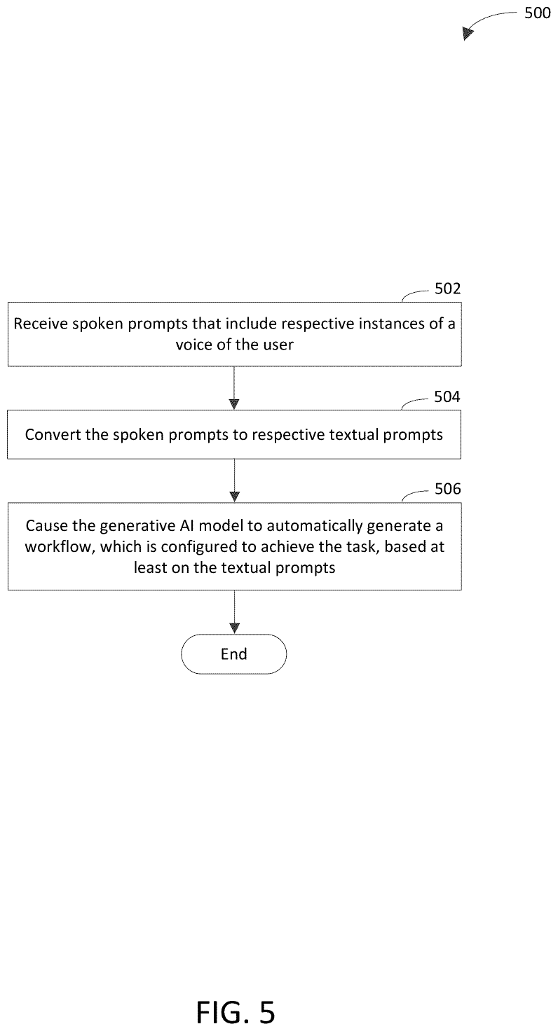

In another example embodiment, steps 306 and 308 of flowchart 300 are replaced with one or more of the steps shown in flowchart 500 of FIG. 5. As shown in FIG. 5, the method of flowchart 500 begins at step 502. In step 502, receiving spoken prompts that include respective instances of a voice of the user. The spoken prompts are responses to the respective inquiries. In an example implementation, the prompt provision logic 710 receives the response prompts.

At step 504, the spoken prompts are converted to respective textual prompts. For instance, the spoken prompts may be converted to the respective textual prompts using a speech recognition technique. A speech recognition technique uses a processor system to recognize spoken language and to convert the spoken language into text. In an example implementation, the prompt provision logic 710 converts the spoken prompts to the respective textual prompts. For example, the prompt provision logic 710 may use the generative AI model 714 to convert the spoken prompts to the respective textual prompts. In accordance with this example, the prompt provision logic 710 may provide digital representations of audio signals that define the spoken prompts as inputs to the generative AI model 714. For instance, by providing the digital representations of the audio signals as the inputs to the generative AI model 714, the prompt provision logic 710 may cause the generative AI model 714 to convert the digital representations of the audio signals into the respective textual prompts. In another example, the prompt provision logic 710 may convert the digital representations of the audio signals into the respective textual prompts without passing the digital representations of the audio signals to the generative AI model 714.

At step 506, the generative AI model is caused to automatically generate the workflow, which is configured to achieve the task, based at least on the textual prompts. For instance, the generative AI model may be caused to automatically generate the workflow based at least on inputs to the generative AI model by providing the textual prompts as the inputs to the generative AI model. In an example implementation, the prompt provision logic 710 causes the generative AI model 714 to automatically generate the workflow 736, which is configured to achieve the task, based at least on the textual prompts. In an aspect, the prompt provision logic 710 causes the generative AI model 714 to automatically generate the workflow 736 based at least on inputs to the generative AI model 714 by providing the textual prompts as the inputs to the generative AI model 714. In another aspect, the prompt provision logic 710 causes the generative AI model 714 to automatically generate the workflow 736 based at least on the textual prompts by providing digital representations of audio signals that define the spoken prompts as inputs to the generative AI model 714, which causes the generative AI model 714 to convert the digital representations of the audio signals to the textual prompts.

In an aspect of this embodiment, steps 502 and 504 are included in step 306 of flowchart 300. In another aspect of this embodiment, step 506 is included in step 308 of flowchart 300.

In another aspect of this embodiment, the method of flowchart 300 further includes converting the inquiries from a textual format, which is generated by the generative AI model, to a voice format. For instance, the inquiries may be converted from the textual format to the voice format using a speech synthesis technique. A speech synthesis technique uses a processor system to convert natural language text to speech. For instance, the speech may be included in an audio signal that represents (e.g., characterizes) the inquiries. In an example implementation, the inquiry provision logic 712 converts the inquiries 732 from a textual format, which is generated by the generative AI model 714, to a voice format. In accordance with this aspect, providing the inquiries at step 304 includes causing generation of the spoken prompts by providing the inquiries in the voice format. In an example implementation, the inquiry provision logic 712 causes generation of the spoken prompts, which are received by the prompt provision logic 710, by providing the inquiries 732 in the voice format.

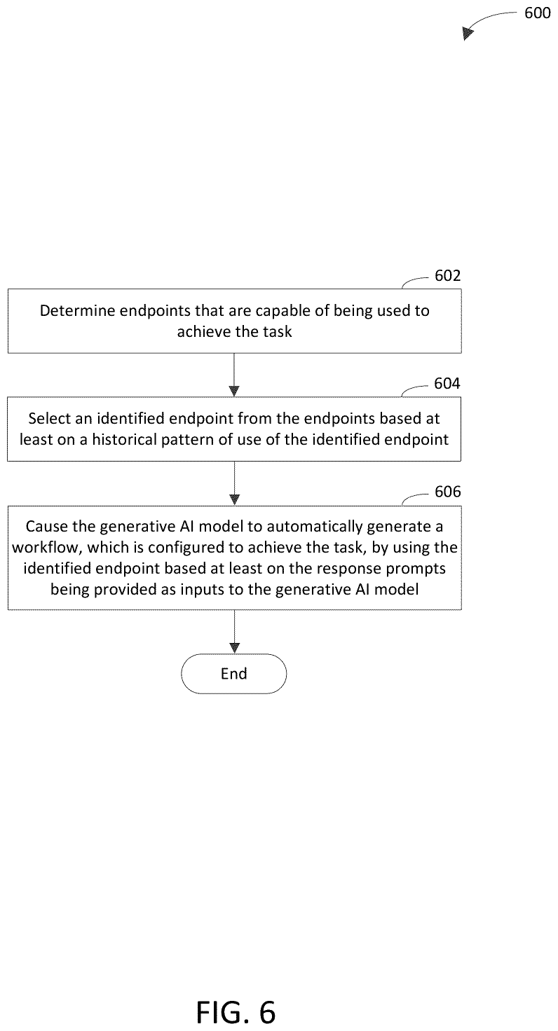

In yet another example embodiment, step 308 of flowchart 300 is replaced with one or more of the steps shown in flowchart 600 of FIG. 6. As shown in FIG. 6, the method of flowchart 600 begins at step 602. In step 602, endpoints that are capable of being used to achieve the task are determined. An endpoint is an entity (e.g., software, firmware, hardware, or any combination thereof) that is capable of performing an operation in a workflow. Examples of an endpoint include a desktop application, a web application, and a web service. A desktop application is an application that is configured to run locally on a user computing system. Example types of a desktop application include an Internet browser, productivity software (e.g., a word processor, a spreadsheet editor, presentation software), and security software. A web application is an application that is accessed using a web browser. Example types of a web application include a web-based productivity application and a web-based messaging service (e.g., an email service). A web service is (1) a service that is provided by a first computing system to a second computing system and for which communications between the first and second computing system is performed via the Internet or (2) a service that runs on a computing system and serves web documents based on (e.g., in response to) requests that are received at a specified port. A cloud storage service is one example type of a web service. It will be recognized that a web application programming interface (API) may be used to connect to an endpoint.

In an example implementation, the endpoint determination logic 724 determines the endpoints that are capable of being used to achieve the task. In accordance with this implementation, the endpoint determination logic 724 generates endpoint information 740 to indicate (e.g., specify) the endpoints that are capable of being used to achieve the task. For instance, the endpoint determination logic 724 may configure the endpoint information 740 to include identifiers that uniquely identify the respective endpoints.

At step 604, an identified endpoint is selected from the endpoints based at least on a historical pattern of use of the identified endpoint. For example, the historical pattern of use may represent use of the identified endpoint by the user, by a team that includes the user, by an organization that includes the user, or by an industry that includes the user. In another example, the historical pattern of use may be indicated by workflows associated with the user, a team that includes the user, an organization that includes the user, or an industry that includes the user. In an example implementation, the endpoint selection logic 726 selects the identified endpoint from the endpoints that are capable of being used to achieve the task, as indicated by the endpoint information 740, based at least on the historical pattern of use of the identified endpoint. In an aspect, the historical information 738, which is stored in store 722, indicates the historical pattern of use of the identified endpoint. For example, the historical information 738 may include multiple entries such that each entry indicates a use (e.g., a type of use) of the identified endpoint. In accordance with this example, each entry may further indicate attribute(s) of the respective use, such as a time at which the respective use of the identified endpoint occurred. The endpoint selection logic 726 generates an endpoint identifier 742, which indicates the identified endpoint. For instance, the endpoint identifier 742 may indicate that the identified endpoint was selected from the endpoints that are capable of being used to achieve the task.

At step 606, the generative AI model is caused to automatically generate a workflow, which is configured to achieve the task, by using the identified endpoint based at least on the response prompts being provided as inputs to the generative AI model. The generate AI model may be caused to automatically generate the workflow by using the identified endpoint further based at least on the identified endpoint being selected from the endpoints. In an example implementation, the prompt provision logic 710 and the endpoint selection logic 726 collaboratively cause the generative AI model 714 to automatically generate the workflow 736, which is configured to achieve the task, by using the identified endpoint, as indicated by the endpoint identifier 742, based at least on the response prompts 730 being provided as inputs to the generative AI model 714. For instance, the endpoint selection logic 726 may contribute to causing the generative AI model 714 to use the identified endpoint to automatically generate the workflow 736 by generating the endpoint identifier 742, which the generative AI model 714 uses to determine the identified endpoint.

In an aspect of this embodiment, step 606 is included in step 308 of flowchart 300.

In still another example embodiment, the method of flowchart 300 further includes executing the workflow. For instance, the workflow may be executed based at least on performance of a scheduled trigger action or performance of an asynchronous event. In an example implementation, the workflow execution logic 720 executes the workflow 736.

It will be recognized that the computing system 700 may not include one or more of the inquiry-based workflow generation logic 708, the prompt provision logic 710, the inquiry provision logic 712, the generative AI model 714, the display logic 716, the endpoint identification logic 718, the workflow execution logic 720, the store 722, the endpoint determination logic 724, and/or the endpoint selection logic 726. Furthermore, the computing system 700 may include components in addition to or in lieu of the inquiry-based workflow generation logic 708, the prompt provision logic 710, the inquiry provision logic 712, the generative AI model 714, the display logic 716, the endpoint identification logic 718, the workflow execution logic 720, the store 722, the endpoint determination logic 724, and/or the endpoint selection logic 726.

Although the operations of some of the disclosed methods are described in a particular, sequential order for convenient presentation, it should be understood that this manner of description encompasses rearrangement, unless a particular ordering is required by specific language set forth herein. For example, operations described sequentially may in some cases be rearranged or performed concurrently. Moreover, for the sake of simplicity, the attached figures may not show the various ways in which the disclosed methods may be used in conjunction with other methods.

Any one or more of the inquiry-based workflow generation logic 108, the inquiry-based workflow generation logic 208, the prompt provision logic 210, the inquiry provision logic 212, the generative AI model 214, the inquiry-based workflow generation logic 708, the prompt provision logic 710, the inquiry provision logic 712, the generative AI model 714, the display logic 716, the endpoint identification logic 718, the workflow execution logic 720, the store 722, the endpoint determination logic 724, the endpoint selection logic 726, activity diagram 200, flowchart 300, flowchart 400, flowchart 500, and/or flowchart 600 may be implemented in hardware, software, firmware, or any combination thereof.

For example, any one or more of the inquiry-based workflow generation logic 108, the inquiry-based workflow generation logic 208, the prompt provision logic 210, the inquiry provision logic 212, the generative AI model 214, the inquiry-based workflow generation logic 708, the prompt provision logic 710, the inquiry provision logic 712, the generative AI model 714, the display logic 716, the endpoint identification logic 718, the workflow execution logic 720, the store 722, the endpoint determination logic 724, the endpoint selection logic 726, activity diagram 200, flowchart 300, flowchart 400, flowchart 500, and/or flowchart 600 may be implemented, at least in part, as computer program code configured to be executed in one or more processors.

In another example, any one or more of the inquiry-based workflow generation logic 108, the inquiry-based workflow generation logic 208, the prompt provision logic 210, the inquiry provision logic 212, the generative AI model 214, the inquiry-based workflow generation logic 708, the prompt provision logic 710, the inquiry provision logic 712, the generative AI model 714, the display logic 716, the endpoint identification logic 718, the workflow execution logic 720, the store 722, the endpoint determination logic 724, the endpoint selection logic 726, activity diagram 200, flowchart 300, flowchart 400, flowchart 500, and/or flowchart 600 may be implemented, at least in part, as hardware logic/electrical circuitry. Such hardware logic/electrical circuitry may include one or more hardware logic components. Examples of a hardware logic component include but are not limited to a field-programmable gate array (FPGA), an application-specific integrated circuit (ASIC), an application-specific standard product (ASSP), a system-on-a-chip system (SoC), a complex programmable logic device (CPLD), etc. For instance, a SoC may include an integrated circuit chip that includes one or more of a processor (e.g., a microcontroller, microprocessor, digital signal processor (DSP), etc.), memory, one or more communication interfaces, and/or further circuits and/or embedded firmware to perform its functions.

### II. Further Discussion of Some Example Embodiments

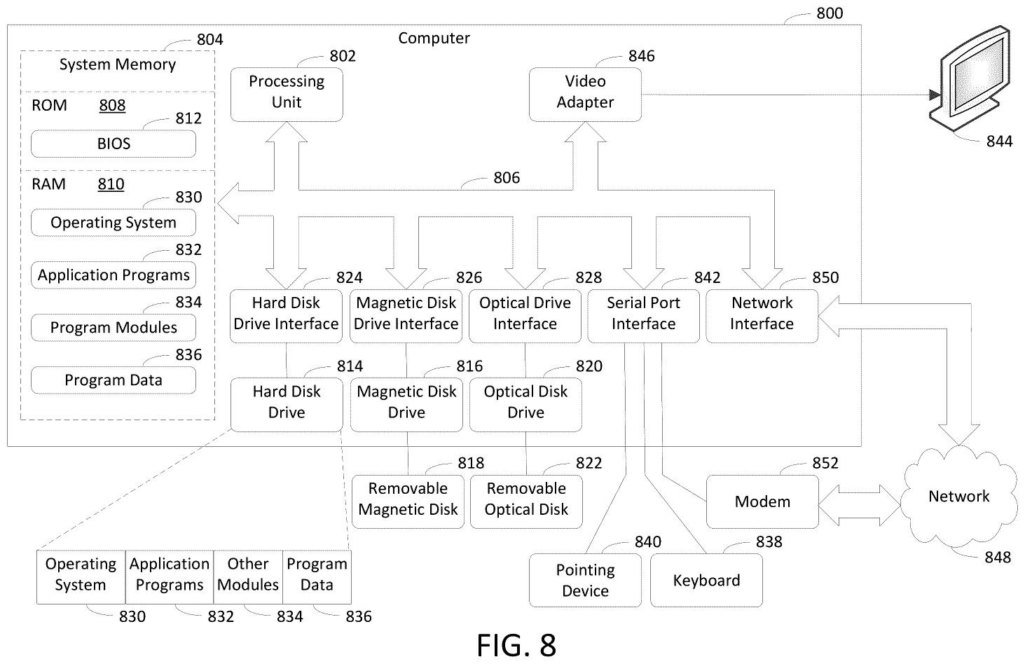

(A1) An example system (FIG. 1, 102A-102M, 106A-106N; FIG. 2, 206; FIG. 7, 700; FIG. 8, 800) comprises a processor system (FIG. 8, 802) and a memory (FIG. 8, 804, 808, 810) that stores computer-executable instructions. The computer-executable instructions are executable by the processor system to provide (FIG. 2, 222; FIG. 3, 302) an initial prompt (FIG. 7, 728) from a user as an input to a generative AI model (FIG. 7, 714). The initial prompt indicates that a task is to be completed. The computer-executable instructions are executable by the processor system further to provide (FIG. 2, 230, 240, 250; FIG. 3, 304) a plurality of inquiries (FIG. 7, 732), which are generated by the generative AI model based at least on the initial prompt, in a first successive order to the user. The plurality of inquiries solicit information regarding the task. The computer-executable instructions are executable by the processor system further to receive (FIG. 2, 232, 242, 252; FIG. 3, 306) a plurality of response prompts (FIG. 7, 730), which are responses to the plurality of respective inquiries, in a second successive order that corresponds to the first successive order. The computer-executable instructions are executable by the processor system further to cause (FIG. 2, 224, 234, 244, 254; FIG. 3, 308) the generative AI model to automatically generate a workflow (FIG. 7, 736), which is configured to achieve the task, based at least on inputs to the generative AI model by providing the plurality of response prompts as the inputs to the generative AI model.

(A2) In the example system of A1, wherein the computer-executable instructions are executable by the processor system further to: provide a graphical representation of the workflow to the user.

(A3) In the example system of any of A1-A2, wherein the computer-executable instructions are executable by the processor system to: cause the AI model to incrementally modify the workflow to include a plurality of incremental changes in the second successive order; and wherein the plurality of incremental changes are triggered by the plurality of respective response prompts.

(A4) In the example system of any of A1-A3, wherein the computer-executable instructions are executable by the processor system to: receive a plurality of spoken prompts that include respective instances of a voice of the user, wherein the plurality of spoken prompts are the responses to the plurality of respective inquiries; convert the plurality of spoken prompts to a plurality of respective textual prompts; and cause the generative AI model to automatically generate the workflow based at least on the plurality of textual prompts.

(A5) In the example system of any of A1-A4, wherein the computer-executable instructions are executable by the processor system to: convert the plurality of inquiries from a textual format, which is generated by the generative AI model, to a voice format; and cause generation of the plurality of spoken prompts by providing the plurality of inquiries in the voice format.

(A6) In the example system of any of A1-A5, wherein the computer-executable instructions are executable by the processor system further to: for each response prompt of the plurality of response prompts, cause a next successive inquiry of the plurality of inquiries to be generated by the generative AI model by providing the respective response prompt together with contextual information, which includes context regarding the respective response prompt, as inputs to the generative AI model, the contextual information including at least a preceding prompt that precedes the respective response prompt, the preceding prompt including the initial prompt or another response prompt of the plurality of response prompts.

(A7) In the example system of any of A1-A6, for each response prompt of the plurality of response prompts, the contextual information regarding the respective response prompt includes the initial prompt and each response prompt of the plurality of response prompts that precedes the respective response prompt.

(A8) In the example system of any of A1-A7, for each response prompt of the plurality of response prompts, the contextual information regarding the respective response prompt includes the initial prompt and each response prompt of the plurality of response prompts that precedes the respective response prompt up to a maximum number of the response prompts.

(A9) In the example system of any of A1-A8, wherein the computer-executable instructions are executable by the processor system to: determine a plurality of endpoints that are capable of being used to achieve the task; select an identified endpoint from the plurality of endpoints based at least on a historical pattern of use of the identified endpoint; and based at least on the identified endpoint being selected from the plurality of endpoints, cause the generative AI model to automatically generate the workflow by using the identified endpoint.

(A10) In the example system of any of A1-A9, wherein the plurality of inquiries includes an identified inquiry that requests which endpoint of a plurality of endpoints is to be used to achieve the task, wherein each of the plurality of endpoints is capable of being used to achieve the task; wherein the plurality of response prompts includes an identified response prompt that is a response to the identified inquiry, wherein the identified response prompt indicates that a designated endpoint of the plurality of endpoints is to be used to achieve the task; and wherein the computer-executable instructions are executable by the processor system to: based at least on the identified response prompt indicating that the designated endpoint is to be used to achieve the task, cause the generative AI model to automatically generate the workflow, which is configured to achieve the task by using the designated endpoint.

(A11) In the example system of any of A1-A10, wherein the computer-executable instructions are executable by the processor system to: provide a first subset of the plurality of inquiries during a first user session of the user; receive a first subset of the plurality of response prompts, which corresponds to the first subset of the plurality of inquiries, during the first user session of the user; provide a second subset of the plurality of inquiries during a second user session of the user that temporally follows the first user session, the first user session and the second user session being temporally noncontiguous; and receive a second subset of the plurality of response prompts, which corresponds to the second subset of the plurality of inquiries, during the second user session of the user; and wherein an inquiry in the second subset of the plurality of inquiries, which is provided during the second user session of the user, is based at least on a response prompt in the first subset of the plurality of response prompts, which is received during the first user session of the user.

(A12) In the example system of any of A1-A11, wherein the plurality of inquiries includes an identified inquiry that requests identification of a trigger action that is to trigger execution of the workflow; wherein the plurality of response prompts includes an identified response prompt that is a response to the identified inquiry, wherein the identified response prompt identifies the trigger action that is to trigger the execution of the workflow; and wherein the computer-executable instructions are executable by the processor system to: based at least on the identified response prompt identifying the trigger action, cause the generative AI model to configure the workflow such that performance of the trigger action triggers the execution of the workflow.

(A13) In the example system of any of A1-A12, wherein the identified response prompt indicates that the trigger action is to be performed on a periodic schedule, which is based on a period that is equal to a specified fixed amount of time; and wherein the plurality of inquiries includes a follow-up inquiry, which is generated by the generative AI model based at least on the period indicated by the identified response not satisfying a criterion, the follow-up inquiry proposing that the periodic schedule be based on an alternative period that satisfies the criterion.

(A14) In the example system of any of A1-A13, wherein the identified response prompt identifies the trigger action to be an asynchronous event of a designated type.

(A15) In the example system of any of A1-A14, wherein the computer-executable instructions are executable by the processor system to: cause the generative AI model to configure the workflow to require human approval as a prerequisite for performance of an operation in the workflow by providing information about the operation as an input to the generative AI model, the information about the operation providing context regarding a response prompt in the plurality of response prompts.

(A16) In the example system of any of A1-A15, wherein the plurality of inquiries includes an identified inquiry that identifies a plurality of operations that are capable of being added to the workflow, wherein the identified inquiry requests an indication of which operation of the plurality of operations is to be added to the workflow; wherein the plurality of response prompts includes an identified response prompt that is a response to the identified inquiry, wherein the identified response prompt indicates selection of a designated operation from the plurality of operations; and wherein the computer-executable instructions are executable by the processor system to: based at least on the identified response prompt indicating the selection of the designated operation from the plurality of operations, cause the generative AI model to add the designated operation to the workflow.

(B1) An example method is implemented by a computing system (FIG. 1, 102A-102M, 106A-106N; FIG. 2, 206; FIG. 7, 700; FIG. 8, 800). The method comprises providing (FIG. 2, 222; FIG. 3, 302) an initial prompt (FIG. 7, 728) from a user as an input to a generative AI model (FIG. 7, 714). The initial prompt indicates that a task is to be completed. The method further comprises providing (FIG. 2, 230, 240, 250; FIG. 3, 304) a plurality of inquiries (FIG. 7, 732), which are generated by the generative AI model based at least on the initial prompt, in a first successive order to the user. The plurality of inquiries solicit information regarding the task. The method further comprises receiving (FIG. 2, 232, 242, 252; FIG. 3, 306) a plurality of response prompts (FIG. 7, 730), which are responses to the plurality of respective inquiries, in a second successive order that corresponds to the first successive order. The method further comprises causing (FIG. 2, 224, 234, 244, 254; FIG. 3, 308) the generative AI model to automatically generate a workflow (FIG. 7, 736), which is configured to achieve the task, based at least on inputs to the generative AI model by providing the plurality of response prompts as the inputs to the generative AI model.

(B2) In the example method of B1, further comprising: providing a graphical representation of the workflow to the user.

(B3) In the example method of any of B1-B2, wherein causing the generative AI model to automatically generate the workflow comprises: causing the AI model to incrementally modify the workflow to include a plurality of incremental changes in the second successive order; and wherein the plurality of incremental changes are triggered by the plurality of respective response prompts.

(B4) In the example method of any of B1-B3, wherein receiving the plurality of response prompts comprises: receiving a plurality of spoken prompts that include respective instances of a voice of the user, wherein the plurality of spoken prompts are the responses to the plurality of respective inquiries; and converting the plurality of spoken prompts to a plurality of respective textual prompts; and wherein the generative AI model is caused to automatically generate the workflow based at least on the plurality of textual prompts.

(B5) In the example method of any of B1-B4, further comprising: converting the plurality of inquiries from a textual format, which is generated by the generative AI model, to a voice format; wherein providing the plurality of inquiries comprises: causing generation of the plurality of spoken prompts by providing the plurality of inquiries in the voice format.

(B6) In the example method of any of B1-B5, further comprising: for each response prompt of the plurality of response prompts, causing a next successive inquiry of the plurality of inquiries to be generated by the generative AI model by providing the respective response prompt together with contextual information, which includes context regarding the respective response prompt, as inputs to the generative AI model, the contextual information including at least a preceding prompt that precedes the respective response prompt, the preceding prompt including the initial prompt or another response prompt of the plurality of response prompts.

(B7) In the example method of any of B1-B6, wherein, for each response prompt of the plurality of response prompts, the contextual information regarding the respective response prompt includes the initial prompt and each response prompt of the plurality of response prompts that precedes the respective response prompt.

(B8) In the example method of any of B1-B7, wherein, for each response prompt of the plurality of response prompts, the contextual information regarding the respective response prompt includes the initial prompt and each response prompt of the plurality of response prompts that precedes the respective response prompt up to a maximum number of the response prompts.

(B9) In the example method of any of B1-B8, further comprising: determining a plurality of endpoints that are capable of being used to achieve the task; and selecting an identified endpoint from the plurality of endpoints based at least on a historical pattern of use of the identified endpoint; wherein causing the generative AI model to automatically generate the workflow comprises: based at least on the identified endpoint being selected from the plurality of endpoints, causing the generative AI model to automatically generate the workflow by using the identified endpoint.

(B10) In the example method of any of B1-B9, wherein the plurality of inquiries includes an identified inquiry that requests which endpoint of a plurality of endpoints is to be used to achieve the task, wherein each of the plurality of endpoints is capable of being used to achieve the task; wherein the plurality of response prompts includes an identified response prompt that is a response to the identified inquiry, wherein the identified response prompt indicates that a designated endpoint of the plurality of endpoints is to be used to achieve the task; and wherein causing the generative AI model to automatically generate the workflow comprises: based at least on the identified response prompt indicating that the designated endpoint is to be used to achieve the task, causing the generative AI model to automatically generate the workflow, which is configured to achieve the task by using the designated endpoint.

(B11) In the example method of any of B1-B10, wherein providing the plurality of inquiries comprises: providing a first subset of the plurality of inquiries during a first user session of the user; and providing a second subset of the plurality of inquiries during a second user session of the user that temporally follows the first user session, the first user session and the second user session being temporally noncontiguous; wherein receiving the plurality of response prompts comprises: receiving a first subset of the plurality of response prompts, which corresponds to the first subset of the plurality of inquiries, during the first user session of the user; and receiving a second subset of the plurality of response prompts, which corresponds to the second subset of the plurality of inquiries, during the second user session of the user; and wherein an inquiry in the second subset of the plurality of inquiries, which is provided during the second user session of the user, is based at least on a response prompt in the first subset of the plurality of response prompts, which is received during the first user session of the user.

(B12) In the example method of any of B1-B11, wherein the plurality of inquiries includes an identified inquiry that requests identification of a trigger action that is to trigger execution of the workflow; wherein the plurality of response prompts includes an identified response prompt that is a response to the identified inquiry, wherein the identified response prompt identifies the trigger action that is to trigger the execution of the workflow; and wherein causing the generative AI model to automatically generate the workflow comprises: based at least on the identified response prompt identifying the trigger action, causing the generative AI model to configure the workflow such that performance of the trigger action triggers the execution of the workflow.

(B13) In the example method of any of B1-B12, wherein the identified response prompt indicates that the trigger action is to be performed on a periodic schedule, which is based on a period that is equal to a specified fixed amount of time; and wherein the plurality of inquiries includes a follow-up inquiry, which is generated by the generative AI model based at least on the period indicated by the identified response not satisfying a criterion, the follow-up inquiry proposing that the periodic schedule be based on an alternative period that satisfies the criterion.

(B14) In the example method of any of B1-B13, wherein the identified response prompt identifies the trigger action to be an asynchronous event of a designated type.

(B15) In the example method of any of B1-B14, wherein causing the generative AI model to automatically generate the workflow comprises: causing the generative AI model to configure the workflow to require human approval as a prerequisite for performance of an operation in the workflow by providing information about the operation as an input to the generative AI model, the information about the operation providing context regarding a response prompt in the plurality of response prompts.

(B16) In the example method of any of B1-B15, wherein the plurality of inquiries includes an identified inquiry that identifies a plurality of operations that are capable of being added to the workflow, wherein the identified inquiry requests an indication of which operation of the plurality of operations is to be added to the workflow; wherein the plurality of response prompts includes an identified response prompt that is a response to the identified inquiry, wherein the identified response prompt indicates selection of a designated operation from the plurality of operations; and wherein causing the generative AI model to automatically generate the workflow comprises: based at least on the identified response prompt indicating the selection of the designated operation from the plurality of operations, causing the generative AI model to add the designated operation to the workflow.

(C1) An example computer program product (FIG. 8, 818, 822) comprising a computer-readable storage medium having instructions recorded thereon for enabling a processor-based system (FIG. 1, 102A-102M, 106A-106N; FIG. 2, 206; FIG. 7, 700; FIG. 8, 800) to perform operations. The operations comprise providing (FIG. 2, 222; FIG. 3, 302) an initial prompt (FIG. 7, 728) from a user as an input to a generative AI model (FIG. 7, 714). The initial prompt indicates that a task is to be completed. The operations further comprise providing (FIG. 2, 230, 240, 250; FIG. 3, 304) a plurality of inquiries (FIG. 7, 732), which are generated by the generative AI model based at least on the initial prompt, in a first successive order to the user. The plurality of inquiries solicit information regarding the task. The operations further comprise receiving (FIG. 2, 232, 242, 252; FIG. 3, 306) a plurality of response prompts (FIG. 7, 730), which are responses to the plurality of respective inquiries, in a second successive order that corresponds to the first successive order. The operations further comprise causing (FIG. 2, 224, 234, 244, 254; FIG. 3, 308) the generative AI model to automatically generate a workflow (FIG. 7, 736), which is configured to achieve the task, based at least on inputs to the generative AI model by providing the plurality of response prompts as the inputs to the generative AI model.

### III. Example Computer System

FIG. 8 depicts an example computer 800 in which embodiments may be implemented. Any one or more of the user devices 102A-102M and/or any one or more of the servers 106A-106N shown in FIG. 1; the user device 202 and/or the server(s) 206 shown in FIG. 2; and/or the computing system 700 shown in FIG. 7 may be implemented using computer 800, including one or more features of computer 800 and/or alternative features. Computer 800 may be a general-purpose computing device in the form of a conventional personal computer, a mobile computer, or a workstation, for example, or computer 800 may be a special purpose computing device. The description of computer 800 provided herein is provided for purposes of illustration, and is not intended to be limiting. Embodiments may be implemented in further types of computer systems, as would be known to persons skilled in the relevant art(s).

As shown in FIG. 8, computer 800 includes a processing unit 802, a system memory 804, and a bus 806 that couples various system components including system memory 804 to processing unit 802. Bus 806 represents one or more of any of several types of bus structures, including a memory bus or memory controller, a peripheral bus, an accelerated graphics port, and a processor or local bus using any of a variety of bus architectures. System memory 804 includes read only memory (ROM) 808 and random access memory (RAM) 810. A basic input/output system 812 (BIOS) is stored in ROM 808.

Computer 800 also has one or more of the following drives: a hard disk drive 814 for reading from and writing to a hard disk, a magnetic disk drive 816 for reading from or writing to a removable magnetic disk 818, and an optical disk drive 820 for reading from or writing to a removable optical disk 822 such as a CD ROM, DVD ROM, or other optical media. Hard disk drive 814, magnetic disk drive 816, and optical disk drive 820 are connected to bus 806 by a hard disk drive interface 824, a magnetic disk drive interface 826, and an optical drive interface 828, respectively. The drives and their associated computer-readable storage media provide nonvolatile storage of computer-readable instructions, data structures, program modules and other data for the computer. Although a hard disk, a removable magnetic disk and a removable optical disk are described, other types of computer-readable storage media can be used to store data, such as flash memory cards, digital video disks, random access memories (RAMs), read only memories (ROM), and the like.

A number of program modules may be stored on the hard disk, magnetic disk, optical disk, ROM, or RAM. These programs include an operating system 830, one or more application programs 832, other program modules 834, and program data 836. Application programs 832 or program modules 834 may include, for example, computer program logic for implementing any one or more of (e.g., at least a portion of) the inquiry-based workflow generation logic 108, the inquiry-based workflow generation logic 208, the prompt provision logic 210, the inquiry provision logic 212, the generative AI model 214, the inquiry-based workflow generation logic 708, the prompt provision logic 710, the inquiry provision logic 712, the generative AI model 714, the display logic 716, the endpoint identification logic 718, the workflow execution logic 720, the store 722, the endpoint determination logic 724, the endpoint selection logic 726, activity diagram 200 (including any activity of activity diagram 200), flowchart 300 (including any step of flowchart 300), flowchart 400 (including any step of flowchart 400), flowchart 500 (including any step of flowchart 500), and/or flowchart 600 (including any step of flowchart 600), as described herein.

A user may enter commands and information into the computer 800 through input devices such as keyboard 838 and pointing device 840. Other input devices (not shown) may include a microphone, joystick, game pad, satellite dish, scanner, touch screen, camera, accelerometer, gyroscope, or the like. These and other input devices are often connected to the processing unit 802 through a serial port interface 842 that is coupled to bus 806, but may be connected by other interfaces, such as a parallel port, game port, or a universal serial bus (USB).

A display device 844 (e.g., a monitor) is also connected to bus 806 via an interface, such as a video adapter 846. In addition to display device 844, computer 800 may include other peripheral output devices (not shown) such as speakers and printers.

Computer 800 is connected to a network 848 (e.g., the Internet) through a network interface or adapter 850, a modem 852, or other means for establishing communications over the network. Modem 852, which may be internal or external, is connected to bus 806 via serial port interface 842.

As used herein, the terms “computer program medium” and “computer-readable storage medium” are used to generally refer to media (e.g., non-transitory media) such as the hard disk associated with hard disk drive 814, removable magnetic disk 818, removable optical disk 822, as well as other media such as flash memory cards, digital video disks, random access memories (RAMs), read only memories (ROM), and the like. A computer-readable storage medium is not a signal, such as a carrier signal or a propagating signal. For instance, a computer-readable storage medium may not include a signal. Accordingly, a computer-readable storage medium does not constitute a signal per se. Such computer-readable storage media are distinguished from and non-overlapping with communication media (do not include communication media). Communication media embodies computer-readable instructions, data structures, program modules or other data in a modulated data signal such as a carrier wave. The term “modulated data signal” means a signal that has one or more of its characteristics set or changed in such a manner as to encode information in the signal. By way of example, and not limitation, communication media includes wireless media such as acoustic, RF, infrared and other wireless media, as well as wired media. Example embodiments are also directed to such communication media.

As noted above, computer programs and modules (including application programs 832 and other program modules 834) may be stored on the hard disk, magnetic disk, optical disk, ROM, or RAM. Such computer programs may also be received via network interface 850 or serial port interface 842. Such computer programs, when executed or loaded by an application, enable computer 800 to implement features of embodiments discussed herein. Accordingly, such computer programs represent controllers of the computer 800.

Example embodiments are also directed to computer program products comprising software (e.g., computer-readable instructions) stored on any computer-useable medium. Such software, when executed in one or more data processing devices, causes data processing device(s) to operate as described herein. Embodiments may employ any computer-useable or computer-readable medium, known now or in the future. Examples of computer-readable mediums include, but are not limited to storage devices such as RAM, hard drives, floppy disks, CD ROMs, DVD ROMs, zip disks, tapes, magnetic storage devices, optical storage devices, MEMS-based storage devices, nanotechnology-based storage devices, and the like.

It will be recognized that the disclosed technologies are not limited to any particular computer or type of hardware. Certain details of suitable computers and hardware are well known and need not be set forth in detail in this disclosure.

### IV. Conclusion

The foregoing detailed description refers to the accompanying drawings that illustrate exemplary embodiments of the present invention. However, the scope of the present invention is not limited to these embodiments, but is instead defined by the appended claims. Thus, embodiments beyond those shown in the accompanying drawings, such as modified versions of the illustrated embodiments, may nevertheless be encompassed by the present invention.

References in the specification to “one embodiment,” “an embodiment,” “an example embodiment,” or the like, indicate that the embodiment described may include a particular feature, structure, or characteristic, but every embodiment may not necessarily include the particular feature, structure, or characteristic. Moreover, such phrases are not necessarily referring to the same embodiment. Furthermore, when a particular feature, structure, or characteristic is described in connection with an embodiment, it is submitted that it is within the knowledge of one skilled in the relevant art(s) to implement such feature, structure, or characteristic in connection with other embodiments whether or not explicitly described.

Descriptors such as “first”, “second”, “third”, etc. are used to reference some elements discussed herein. Such descriptors are used to facilitate the discussion of the example embodiments and do not indicate a required order of the referenced elements, unless an affirmative statement is made herein that such an order is required.

Although the subject matter has been described in language specific to structural features and/or acts, it is to be understood that the subject matter defined in the appended claims is not necessarily limited to the specific features or acts described above. Rather, the specific features and acts described above are disclosed as examples of implementing the claims, and other equivalent features and acts are intended to be within the scope of the claims.

What is claimed is:

1. A system comprising:
a processor system; and
a memory that stores computer-executable instructions that are executable by the processor system to at least:
provide an initial prompt from a user as an input to a generative AI model, the initial prompt indicating that a task is to be completed;
provide a plurality of inquiries, which are generated by the generative AI model based at least on the initial prompt, in a first successive order to the user, the plurality of inquiries soliciting information regarding the task;
receive a plurality of response prompts, which are responses to the plurality of respective inquiries, in a second successive order that corresponds to the first successive order; and
cause the generative AI model to automatically generate a workflow, which is configured to achieve the task, based at least on inputs to the generative AI model by providing the plurality of response prompts as the inputs to the generative AI model.

2. The system of claim 1, wherein the computer-executable instructions are executable by the processor system to:
cause the AI model to incrementally modify the workflow to include a plurality of incremental changes in the second successive order; and
wherein the plurality of incremental changes are triggered by the plurality of respective response prompts.

3. The system of claim 1, wherein the computer-executable instructions are executable by the processor system further to:
for each response prompt of the plurality of response prompts, cause a next successive inquiry of the plurality of inquiries to be generated by the generative AI model by providing the respective response prompt together with contextual information, which includes context regarding the respective response prompt, as inputs to the generative AI model, the contextual information including at least a preceding prompt that precedes the respective response prompt, the preceding prompt including the initial prompt or another response prompt of the plurality of response prompts.

4. The system of claim 3, wherein, for each response prompt of the plurality of response prompts, the contextual information regarding the respective response prompt includes the initial prompt and each response prompt of the plurality of response prompts that precedes the respective response prompt.

5. The system of claim 3, wherein, for each response prompt of the plurality of response prompts, the contextual information regarding the respective response prompt includes the initial prompt and each response prompt of the plurality of response prompts that precedes the respective response prompt up to a maximum number of the response prompts.

6. The system of claim 1, wherein the computer-executable instructions are executable by the processor system to:
determine a plurality of endpoints that are capable of being used to achieve the task;
select an identified endpoint from the plurality of endpoints based at least on a historical pattern of use of the identified endpoint; and
based at least on the identified endpoint being selected from the plurality of endpoints, cause the generative AI model to automatically generate the workflow by using the identified endpoint.

7. The system of claim 1, wherein the computer-executable instructions are executable by the processor system to:
provide a first subset of the plurality of inquiries during a first user session of the user;
receive a first subset of the plurality of response prompts, which corresponds to the first subset of the plurality of inquiries, during the first user session of the user;
provide a second subset of the plurality of inquiries during a second user session of the user that temporally follows the first user session, the first user session and the second user session being temporally noncontiguous; and
receive a second subset of the plurality of response prompts, which corresponds to the second subset of the plurality of inquiries, during the second user session of the user; and
wherein an inquiry in the second subset of the plurality of inquiries, which is provided during the second user session of the user, is based at least on a response prompt in the first subset of the plurality of response prompts, which is received during the first user session of the user.

8. The system of claim 1, wherein the plurality of inquiries includes an identified inquiry that requests identification of a trigger action that is to trigger execution of the workflow;
wherein the plurality of response prompts includes an identified response prompt that is a response to the identified inquiry, wherein the identified response prompt identifies the trigger action that is to trigger the execution of the workflow; and
wherein the computer-executable instructions are executable by the processor system to:
based at least on the identified response prompt identifying the trigger action, cause the generative AI model to configure the workflow such that performance of the trigger action triggers the execution of the workflow.

9. The system of claim 8, wherein the identified response prompt indicates that the trigger action is to be performed on a periodic schedule, which is based on a period that is equal to a specified fixed amount of time; and
wherein the plurality of inquiries includes a follow-up inquiry, which is generated by the generative AI model based at least on the period indicated by the identified response not satisfying a criterion, the follow-up inquiry proposing that the periodic schedule be based on an alternative period that satisfies the criterion.

10. The system of claim 8, wherein the identified response prompt identifies the trigger action to be an asynchronous event of a designated type.

11. The system of claim 1, wherein the computer-executable instructions are executable by the processor system to:
cause the generative AI model to configure the workflow to require human approval as a prerequisite for performance of an operation in the workflow by providing information about the operation as an input to the generative AI model, the information about the operation providing context regarding a response prompt in the plurality of response prompts.

12. The system of claim 1, wherein the plurality of inquiries includes an identified inquiry that identifies a plurality of operations that are capable of being added to the workflow, wherein the identified inquiry requests an indication of which operation of the plurality of operations is to be added to the workflow;
wherein the plurality of response prompts includes an identified response prompt that is a response to the identified inquiry, wherein the identified response prompt indicates selection of a designated operation from the plurality of operations; and
wherein the computer-executable instructions are executable by the processor system to:
based at least on the identified response prompt indicating the selection of the designated operation from the plurality of operations, cause the generative AI model to add the designated operation to the workflow.

13. A method implemented by a computing system, the method comprising:
providing an initial prompt from a user as an input to a generative AI model, the initial prompt indicating that a task is to be completed;
providing a plurality of inquiries, which are generated by the generative AI model based at least on the initial prompt, in a first successive order to the user, the plurality of inquiries soliciting information regarding the task;
receiving a plurality of response prompts, which are responses to the plurality of respective inquiries, in a second successive order that corresponds to the first successive order; and
causing the generative AI model to automatically generate a workflow, which is configured to achieve the task, based at least on inputs to the generative AI model by providing the plurality of response prompts as the inputs to the generative AI model.

14. The method of claim 13, further comprising:
providing a graphical representation of the workflow to the user.

15. The method of claim 13, wherein causing the generative AI model to automatically generate the workflow comprises:
causing the AI model to incrementally modify the workflow to include a plurality of incremental changes in the second successive order; and
wherein the plurality of incremental changes are triggered by the plurality of respective response prompts.

16. The method of claim 13, wherein receiving the plurality of response prompts comprises:
receiving a plurality of spoken prompts that include respective instances of a voice of the user, wherein the plurality of spoken prompts are the responses to the plurality of respective inquiries; and
converting the plurality of spoken prompts to a plurality of respective textual prompts; and
wherein the generative AI model is caused to automatically generate the workflow based at least on the plurality of textual prompts.

17. The method of claim 16, further comprising:
converting the plurality of inquiries from a textual format, which is generated by the generative AI model, to a voice format;
wherein providing the plurality of inquiries comprises:
causing generation of the plurality of spoken prompts by providing the plurality of inquiries in the voice format.

18. The method of claim 13, further comprising:
for each response prompt of the plurality of response prompts, causing a next successive inquiry of the plurality of inquiries to be generated by the generative AI model by providing the respective response prompt together with contextual information, which includes context regarding the respective response prompt, as inputs to the generative AI model, the contextual information including at least a preceding prompt that precedes the respective response prompt, the preceding prompt including the initial prompt or another response prompt of the plurality of response prompts.

19. The method of claim 13, wherein the plurality of inquiries includes an identified inquiry that requests which endpoint of a plurality of endpoints is to be used to achieve the task, wherein each of the plurality of endpoints is capable of being used to achieve the task;
wherein the plurality of response prompts includes an identified response prompt that is a response to the identified inquiry, wherein the identified response prompt indicates that a designated endpoint of the plurality of endpoints is to be used to achieve the task; and
wherein causing the generative AI model to automatically generate the workflow comprises:
based at least on the identified response prompt indicating that the designated endpoint is to be used to achieve the task, causing the generative AI model to automatically generate the workflow, which is configured to achieve the task by using the designated endpoint.

20. A computer program product comprising a computer-readable storage medium having instructions recorded thereon for enabling a processor-based system to perform operations, the operations comprising:
providing an initial prompt from a user as an input to a generative AI model, the initial prompt indicating that a task is to be completed;
providing a plurality of inquiries, which are generated by the generative AI model based at least on the initial prompt, in a first successive order to the user, the plurality of inquiries soliciting information regarding the task;
receiving a plurality of response prompts, which are responses to the plurality of respective inquiries, in a second successive order that corresponds to the first successive order; and
causing the generative AI model to automatically generate a workflow, which is configured to achieve the task, based at least on inputs to the generative AI model by providing the plurality of response prompts as the inputs to the generative AI model.
